(19) United States
(12) Patent Application Publication
(10) Pub. No.: US 2016/0125801 A1
(43) Pub. Date: May 5, 2016

(54) ORGANIC LIGHT-EMITTING DISPLAY APPARATUS AND METHOD OF DRIVING THE SAME

(71) Applicant: SAMSUNG DISPLAY CO., LTD., Yongin-City (KR)

(72) Inventors: Boyong CHUNG, Yongin-City (KR); Haijung IN, Yongin-City (KR); Youngin HWANG, Yongin-City (KR)

(21) Appl. No.: 14/677,133

(22) Filed: Apr. 2, 2015

(30) Foreign Application Priority Data
Nov. 3, 2014 (KR) 10-2014-0151214

(51) Int. Cl. G09G 3/32

(52) U.S. Cl. CPC G09G 3/3225; G09G 3/3266; G09G 2320/045; G09G 2320/0233; G09G 2300/0819

(57) ABSTRACT

An organic light-emitting display apparatus includes a plurality of color pixels. Each of the color pixels includes an organic light-emitting diode (OLED), a driving transistor to control current to the OLED, and a compensation transistor connected between an anode electrode of the OLED and a gate electrode of the driving transistor. The compensation transistor turns on based on a compensation control signal. The compensation control signals for different color pixels have different on-times.

### CROSS-REFERENCE TO RELATED APPLICATION

Korean Patent Application No. 10-2014-0151214, filed on Nov. 3, 2014, and entitled, “Organic Light-Emitting Display Apparatus and Method of Driving the Same,” is incorporated by reference herein in its entirety.

### BACKGROUND

1. Field

One or more embodiments described herein relate to an organic light-emitting display apparatus and a method for driving an organic light-emitting display apparatus.

2. Description of the Related Art

An organic light-emitting display have pixels that emit light using circuits that include organic light-emitting diodes (OLEDs) and thin film transistors. The thin film transistors may be, for example, an amorphous silicon thin film transistor or a polycrystalline silicon thin film transistor.

In an organic light-emitting display, the mobility and threshold voltages of the transistors change over time. For this reason, pixel luminance may not be able to be accurately determined. For example, luminance deviation may occur from characteristic differences between driving transistors of the pixels. This may result in a degradation of display quality.

### SUMMARY

In accordance with one or more embodiments, an organic light-emitting display apparatus includes a plurality of color pixels, each of the color pixels including: an organic light-emitting diode (OLED); a driving transistor to control current to the OLED; and a compensation transistor connected between an anode electrode of the OLED and a gate electrode of the driving transistor, wherein the compensation transistor is turned on based on a compensation control signal and wherein compensation control signal for different color pixels have different on-times.

The color pixels may include at least two of a red pixel, a green pixel, a blue pixel, or a white pixel. The on-time of the compensation control signal of each of the color pixels may be based on a time when a current value of the driving transistor at a compensation period termination point becomes a current value of a predetermined grayscale value.

Each of the color pixels may include a second capacitor having a first electrode connected to a gate electrode of the driving transistor; a first capacitor having a first electrode connected to a second electrode of the second capacitor and a second electrode connected to a first power source, the first power source to supply a first source voltage; and a first transistor connected between the second electrode of the second capacitor and a data line, the first transistor to be turned on based on a scan signal to transfer a data signal to the first electrode of the first capacitor. Each of the color pixels may include a fourth transistor connected between the data line and an anode electrode of the OLED, the fourth transistor to be turned on based on a sensing signal to sense deterioration of the driving transistor or the OLED.

Each of the color pixels may include a first capacitor connected between a data line and a first node; a first transistor to connect the first node to a second node; a second capacitor connected between the second node and a gate electrode of the driving transistor; a fifth transistor to transfer a reference voltage to the first node; and a fourth transistor connected between the second node and a first power source supplying a first source voltage, the fourth transistor to turn on based on an initialization control signal to transfer the first source voltage to the second node.

The fifth transistor may be to be turned on based on a scan signal to transfer the reference voltage to the first node. The first transistor may be turned on by a relay control signal to connect the first node to the second node. When operation of emitting light from the OLED is simultaneously performed in the color pixels, the first transistor may be turned off, the fifth transistor may be turned on, the reference voltage may be transferred to the first node, and a voltage corresponding to a data signal applied to the data line may be stored in the first capacitor.

In accordance with one or more other embodiments, a method for driving an organic light-emitting display apparatus includes turning on a compensation transistor in each of a plurality of color pixels based on a compensation control signal, the compensation control signal to diode-connect a driving transistor in each of the color pixels; sequentially applying a scan signal to the color pixels to apply a data signal to each of the color pixels connected to the scan line; and simultaneously emitting light from the color pixels at a luminance corresponding to a current output to a driving transistor of each of the color pixels, wherein an on-time of the compensation control signal is differently set for different color pixels. The color pixels may be at least two of a red pixel, a green pixel, a blue pixel, or a white pixel.

The on-time of the compensation control signal of each of the color pixels may be based on a time when a current value of the driving transistor at a compensation period termination point becomes a current value of a predetermined grayscale value. Each of the color pixels may include a second capacitor having a first electrode connected to a gate electrode of the driving transistor; a first capacitor having a first electrode, connected to a second electrode of the second capacitor and a second electrode connected to a first power source, the first power source to supply a first source voltage; and a first transistor connected between the other electrode of the second capacitor and a data line, the first transistor to be turned on by a scan signal to transfer a data signal to the first electrode of the first capacitor.

Each of the color pixels may include a fourth transistor connected between the data line and an anode electrode of the OLED, the fourth transistor to be turned on based on a sensing signal to sense deterioration of the driving transistor or the OLED.

Each of the color pixels may include a first capacitor connected between a data line and a first node; a first transistor to connect the first node to a second node; a second capacitor connected between the second node and a gate electrode of the driving transistor; a fifth transistor to transfer a reference voltage to the first node; and a fourth transistor connected between the second node and a first power source to supply a first source voltage, the fourth transistor to be turned on by an initialization control signal to transfer the first source voltage to the second node.

Sequentially supplying the scan signal may include turning off the first transistor, turning on the fifth transistor; transferring the reference voltage to the first node; and storing a voltage in the first capacitor, the voltage corresponding to a data signal applied to the data line. Simultaneously emitting light may include emitting light from the OLED according to current from the driving transistor based on the voltage stored in the second capacitor, wherein the voltage stored in the second capacitor is a voltage which is stored in the first capacitor during a scan operation of a previous frame. A scan period may overlap an emission period.

In accordance with one or more other embodiments, an apparatus includes an output and a driver to supply signals to first and second pixels through the output, wherein the first and second pixels are to emit light of different colors and wherein the driver is to supply a first compensation control signal to the first pixel and a second compensation control signal to the second pixel, the first compensation control signal having a first period and the second compensation control signal having a second period different from the first period, the first and second compensation control signals to compensate for deviations in threshold voltages of driving transistors in respective ones of the first and second pixels. The first pixel may be a red pixel, the second pixel may be a green or blue pixel, and the second period may be longer than the first period.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light-emitting display apparatus;

FIG. 2 illustrates an embodiment of a pixel;

FIG. 3 illustrates an embodiment of a method for driving an organic light-emitting display apparatus;

FIG. 4 illustrates an example of pixels of a pixel unit;

FIG. 5 illustrates an example of a threshold voltage compensation time for a driving transistor of each pixel;

FIG. 6 illustrates an example of a current deviation rate based on a reduction in mobility of a pixel in a certain gray scale range;

FIG. 7 illustrates an example of a current deviation rate based on a reduction in mobility of a pixel in a certain gray scale range as a comparative example to FIG. 6;

FIG. 8 illustrates another embodiment of a pixel;

FIG. 9 illustrates another embodiment of a pixel; and

FIG. 10 illustrates an embodiment of a method for driving an organic light-emitting display apparatus including the pixel of FIG. 9.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

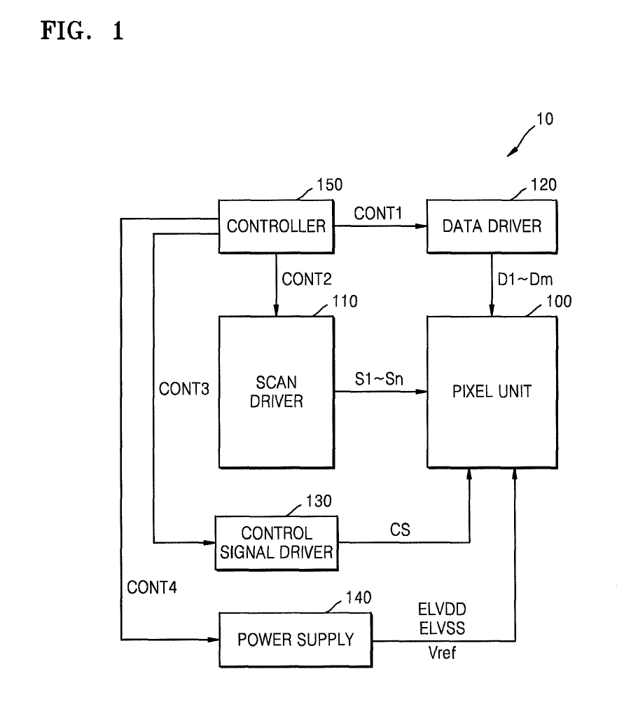

FIG. 1 illustrates an embodiment of an organic light-emitting display apparatus 10 which includes a pixel unit 100, a scan driver 110, a data driver 120, a control signal driver 130, a power supply 140, and a controller 150.

The pixel unit 100 includes a plurality of scan lines, a plurality of data lines, and a plurality of pixels. (For purposes of this disclosure, the term “pixel” may correspond to a unit pixel that emits light corresponding to grayscales values of different colors or a sub-pixel that emits light corresponding to grayscale values of only one color.) The scan lines transfer scan signals S1 to Sn and are arranged in rows that are separated from each other by one or more intervals. The data lines transfer data signals D1 to Dm and are arranged in columns that are separated from each other at one or more intervals. The scan lines and data lines are arranged in a matrix, and the pixels are at intersection of the scan lines and data lines. Each pixel includes a pixel circuit including or coupled to a light emitter.

The pixel unit 100 further includes a plurality of control lines. The control lines transfer a control signal CS and are arranged in rows that are separated from each other by one or more intervals. The control lines may include at least one of a compensation control line, an initialization control line, or a relay control line which transfer a compensation control signal GC, an initialization control signal SUS, and a relay control signal GW, respectively.

The scan driver 110 is connected to the scan lines of the pixel unit 100 and outputs scan signals S1 to Sn based on a combination of a gate-on voltage and a gate-off voltage according to a second control signal CONT2. When the scan signals S1 to Sn have a gate-on voltage, a switching transistor of a pixel connected to a corresponding scan line is turned on. When the scan signals S1 to Sn have a gate-off voltage, the switching transistor is turned off.

The data driver 120 is connected to the data lines of the pixel unit 100, and respectively outputs data signals D1 to Dm representing grayscale values to respective data lines according to a first control signal CONT1. The data driver 120 converts input image data having a grayscale value, input from the controller 150, into a data signal corresponding to a voltage or a current.

The control signal driver 130 is connected to the control lines of the pixel unit 100, and outputs the control signal CS to the control lines according to a third control signal CONT3. The control signal driver 130 outputs a compensation control signal GC to the compensation control lines. The control signal driver 130 outputs an initialization control signal SUS to the initialization control lines. The control signal driver 130 outputs a relay control signal GW to the relay control lines.

The power supply 140 generates a first source voltage ELVDD and a second source voltage ELVSS. The power supply 140 applies the first source voltage ELVDD and second source voltage ELVSS to the pixel unit 100 according to a fourth control signal CONT4. The voltage level of the first source voltage ELVDD is greater than a voltage level of the second source voltage ELVSS. The power supply 140 outputs a reference voltage Vref to the pixel unit 100 based on the fourth control signal CONT4.

The controller 150 receives input image data and an input control signal for controlling the display of the input image data. The input image data and/or the input control signal may be received, for example, from a graphics controller. The input control signal includes, for example, a vertical sync signal Vsync, a horizontal sync signal Hsync, and a main clock MCLK.

The controller 150 generates data signals and first to fourth control signals CONT1 to CONT4 according to the vertical sync signal Vsync, the horizontal sync signal Hsync, and the main clock MCLK. The controller 150 transfers the data signals and the first control signal CONT1 to the data driver 120. The controller 150 transfers the second control signal CONT2 to the scan driver 110. The controller 150 transfers the third control signal CONT3 to the control signal driver 130. The controller 150 transfers the fourth control signal CONT4 to the power supply 140.

Each of the scan driver 110, the data driver 120, the control signal driver 130, the power supply 140, and the controller 150 may be implemented as a separate integrated circuit (IC) chip type or one IC chip type, and may be directly mounted on a substrate on which the pixel unit 100 is provided, mounted on a flexible printed circuit film, attached to a substrate in a tape carrier package (TCP) type, or directly provided on a substrate.

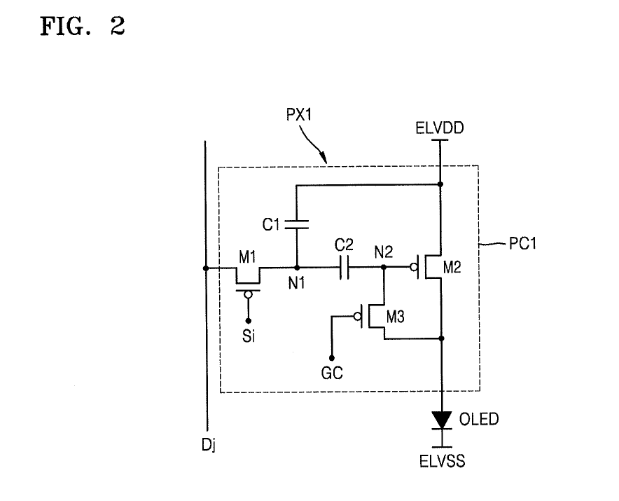

FIG. 2 illustrates an embodiment of a pixel PX1 in the pixel unit 100. The pixel PX 1 includes a pixel circuit PC1 that supplies current to the organic light-emitting diode OLED. The pixel circuit PC1 includes first to third transistors M1 to M3 and first and second capacitors C1 and C2. The first transistor M1 includes a gate electrode connected to a scan line, a first electrode connected to a data line, and a second electrode connected to a first node N1. The first transistor M1 operates as a switching transistor. The first transistor M1 is turned on by a scan signal Si applied through the scan line, and transfers a data signal Dj, input to the first electrode, to the first node N1.

The second transistor M2 includes a gate electrode connected to a second node N2, a first electrode connected to a first power source that supplies a first source voltage ELVDD, and a second electrode connected to an anode electrode of the organic light-emitting diode OLED. The second transistor M2 serves as a driving transistor. The second transistor M2 is turned on/off by a voltage of the second node N2, and thus controls a current supplied to the organic light-emitting diode OLED.

The third transistor M3 includes a gate electrode connected to a compensation control line, a first electrode connected to the gate electrode of the second transistor M2, and a second electrode connected to the anode electrode of the organic light-emitting diode OLED and the second electrode of the second transistor M2. When the third transistor M3 is turned on by a compensation control signal GC applied to the gate electrode of the third transistor M3, the second transistor M2 is diode-connected.

The first capacitor C1 is connected between the first node N1, the first electrode of the second transistor M2, and the first power source which supplies the first source voltage ELVDD. The second capacitor C2 is connected between the first node N1 and the second node N2.

The anode electrode of the organic light-emitting diode OLED is connected to the pixel circuit PC1, and the cathode electrode is connected to a second power source that supplies a second source voltage ELVSS. The organic light-emitting diode OLED emits light with a luminance based on the current supplied from the pixel circuit PC1.

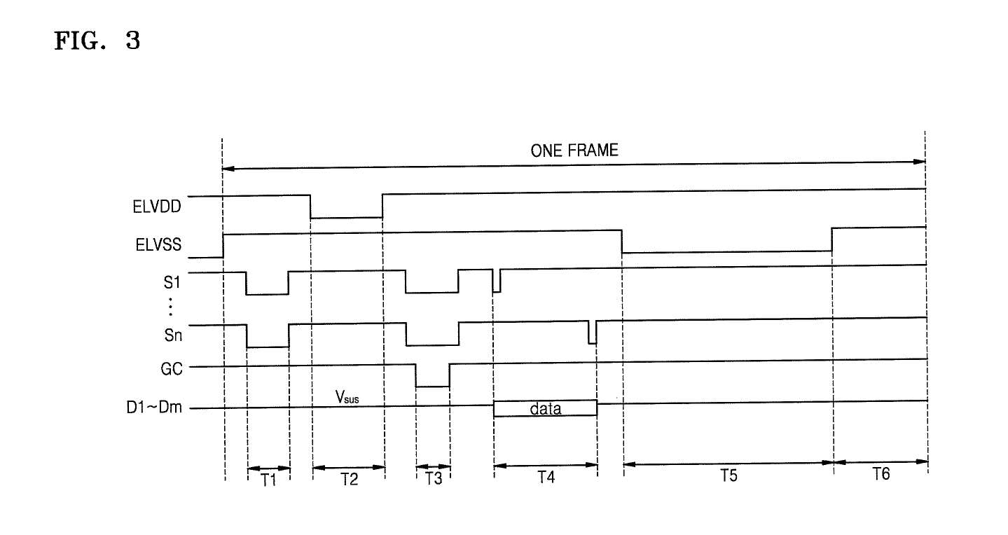

FIG. 3 is a timing diagram illustrating control signals generated in accordance with one embodiment of a method for driving an organic light-emitting display apparatus 10 including the pixel of FIG. 2. Referring to FIGS. 2 and 3, the organic light-emitting display apparatus 10 is driven in a simultaneous emission driving scheme and operates in first to sixth periods T1 to T6 in each frame. The first source voltage ELVDD and the second source voltage ELVSS are applied as at least one or more voltage levels during one frame.

The first period T1 is an initialization period in which the first node N1 and the second node N2 are initialized. During the first period T1, the scan signals S1 to Sn having the gate-on voltage (e.g., a low level) are simultaneously applied to all the scan lines. The first source voltage ELVDD, the second source voltage ELVSS, and the compensation control signal GC having one or more high levels are applied to all the pixels PX1 of the pixel unit 100. Therefore, the first transistor M1 is turned on, and an auxiliary voltage Vsus applied through the data line is transferred to the first node N1. Thus, a voltage of the second node N2 is reduced and the second node N2 maintains an initialization voltage.

The second period T2 is a reset period in which the anode electrode of the organic light-emitting diode OLED is reset. During the second period T2, the first source voltage ELVDD having, for example, a low level is applied to all the pixels PX1 of the pixel unit 100. The second source voltage ELVSS, the scan signals S1 to Sn, and the compensation control signal GC are applied as one or more high levels to the all the pixels PX1. The voltage of the first node N1 is reduced by the first source voltage ELVDD having a low level, and the voltage of the second node N2 is also reduced by a coupling effect of the first and second capacitors C1 and C2. Therefore, the second transistor M2 is turned on, and a voltage at the anode electrode of the organic light-emitting diode OLED is reset to a level of the first source voltage ELVDD having a low level. At this time, the level of the first source voltage ELVDD is lower than that of the second source voltage ELVSS.

The third period T3 is a compensation period in which a characteristic (e.g., threshold voltage and mobility) of the second transistor M2 is compensated. During the third period T3, the scan signals S1 to Sn having a low level are simultaneously applied to all the scan lines. The first source voltage ELVSS and the second source voltage ELVSS which have a high level are applied to all the pixels PX1 of the pixel unit 100, and the compensation control signal GC having a low level is applied to all the pixels PX1. Therefore, the first transistor M1 is turned on, and the auxiliary voltage Vsus applied through the data line is transferred to the first node N1. The auxiliary voltage Vsus may be the same as or different from the auxiliary voltage Vsus applied during the first period T1.

Also, the third transistor M3 is turned on and the second transistor M2 is diode-connected. Therefore, a low-level voltage at the anode electrode of the organic light-emitting diode OLED is transferred to the second node N2, and thus the second transistor M2 is turned on, a voltage at the gate electrode of the second transistor M2 is changed to “ELVDD+Vth”, and Vth is changed to a voltage having a negative (−) value. The ELVDD is a high-level voltage of the first source voltage ELVDD, and Vth is a threshold voltage of the second transistor M2.

The compensation control signal GC is applied at a predetermined on-time (e.g., a time when a low level of the gate-on voltage is applied) for each of a plurality of pixels that emit light of different colors. An on-time of the compensation control signal GC for each color pixel may correspond to a time when a current value of the second transistor M2 at a termination point of the third period T3 becomes a current value of a certain grayscale value of a corresponding color pixel The certain grayscale value may be, for example, a low grayscale value such as a grayscale value of 32 or 64.

As described above, the termination point of the third period T3 is changed for each color pixel. At this time, a current value of the second transistor M2 is also changed for each color pixel, whereby a voltage at the gate electrode of the second transistor M2 is also changed. The voltage at the gate electrode of the second transistor M2 at termination point of the third period T3 is a voltage before becoming “ELVDD+Vth”, and is higher than a voltage “ELVDD+Vth”. Therefore, the threshold voltage and mobility of the second transistor M2 are compensated.

In one exemplary embodiment, the compensation period is differently set for at least two color pixels or for all color pixels, and a current value of the driving transistor is differently set for each color pixel at a termination point of the compensation period, whereby a voltage at the gate electrode of the driving transistor is differently set. Therefore, an output current deviation of the driving transistor is reduced by compensating for mobility deviation of the driving transistor for the at least two or all color pixels. Accordingly, when a characteristic of the driving transistor is reduced due to deterioration, current deviation caused by mobility deviation of each color pixel is reduced or minimized.

The fourth period T4 is a data writing period in which a data signal is applied to each color pixel PX1. During the fourth period T4, the scan signals S1 to Sn having a low level are sequentially input to the respective scan lines, and thus the first transistor M1 is turned on. A plurality of the data signals may be sequentially input to the pixels PX1 connected to the respective scan lines. At this time, the first source voltage ELVDD, the second source voltage ELVSS, and the compensation control signal GC are applied as a high level. The voltage of the first node N1 is changed to a voltage of the data signal, and the voltage of the second node N2 is changed from a voltage at the termination point of the third period T3 by coupling.

The width of each of the sequentially applied scan signals may be, for example, two horizontal time periods 2H, and the widths (for example, a width of an n−1st scan signal Sn−1 and a width of an nth scan signal Sn) of adjacent scan signals may be overlap each other, for example, by one horizontal time period 1H or less. This may prevent insufficient charging due to the RC delay of a signal line caused by enlargement of a display region.

The fifth period T5 is a period in which a current corresponding to a data voltage stored in each color pixel PX1 is applied to the organic light-emitting diode OLED to emit light. During the fifth period T5, the first source voltage ELVDD, the scan signals S1 to Sn, and the compensation control signal GC are applied as a high level, and the second source voltage ELVSS is applied as a low level. The third transistor M3 is turned off and the second transistor M2 is turned on. A current path is formed from the first power source to the cathode electrode of the organic light-emitting diode OLED. Therefore, the organic light-emitting diodes OLED of all the pixels PX1 simultaneously emit light at luminance corresponding to data signals.

The sixth period T6 is an emission off period in which emission of light is turned off for black insertion or dimming after an emission operation. During the sixth period T6, the first source voltage ELVDD, the second source voltage ELVSS, the scan signals S1 to Sn, and the compensation control signal GC are applied as a high level. The sixth period T6 may be optionally omitted.

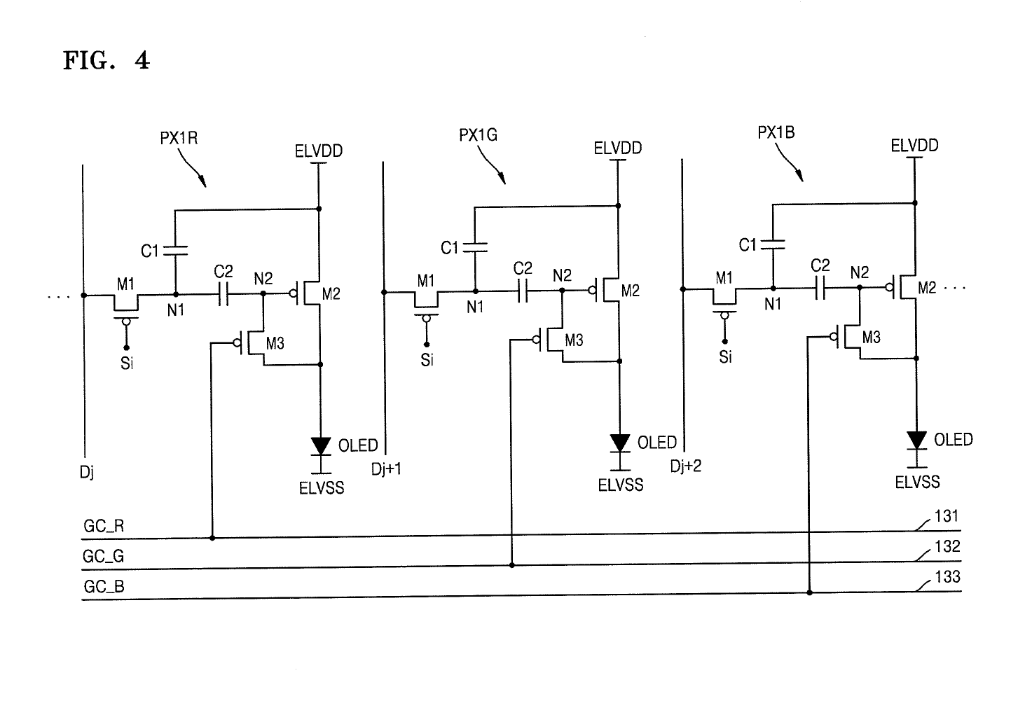

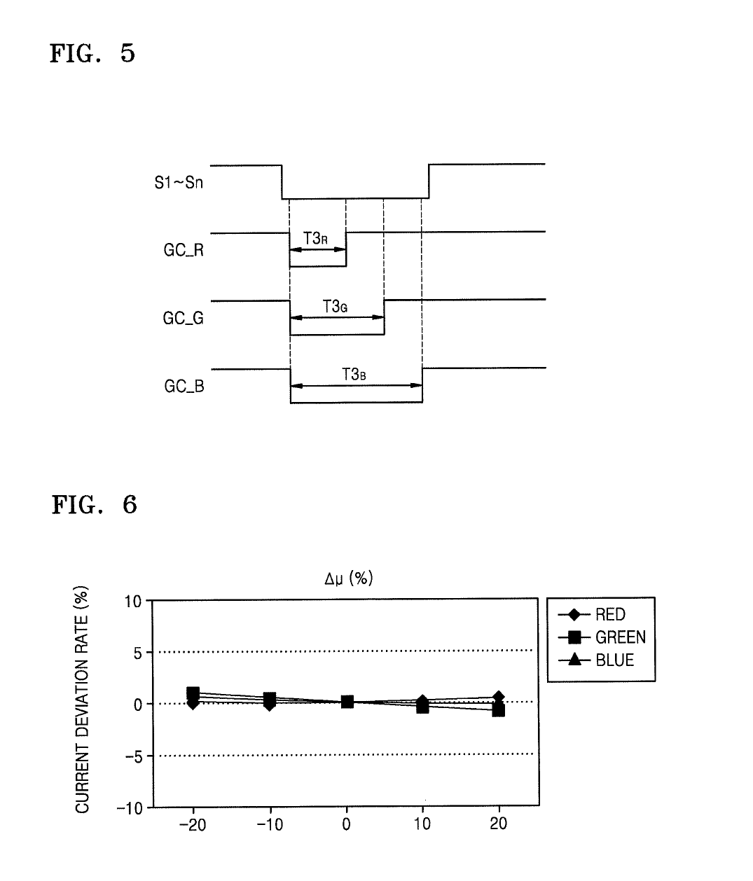

FIG. 4 illustrates an example of a group of pixels of the pixel unit 100 according to an example embodiment. FIG. 5 is a timing diagram illustrating an example of a threshold voltage compensation time of a driving transistor for each of the pixels.

Referring to FIG. 4, a first color pixel PX1R of a jth pixel column, a second color pixel PX1G of a j+1st pixel column, and a third color pixel PX1B of a j+2nd pixel column in an arbitrary pixel row (an ith pixel row) are illustrated.

A first color pixel is may be a red pixel, a second color pixel may be a green pixel, and a third color pixel may be a blue pixel. In another embodiment, the color pixel may be a red, blue, green, or white pixels or may be another color pixel.

The gate electrode of a third transistor M3 of the first color pixel PX1R is connected to a first compensation control line 131 through which a first compensation control signal GC_R is applied.

The gate electrode of a third transistor M3 of the second color pixel PX1G is connected to a second compensation control line 132 through which a second compensation control signal GC_G is applied.

The gate electrode of a third transistor M3 of the third color pixel PX1B is connected to a third compensation control line 133 through which a third compensation control signal GC_B is applied.

In the present embodiment, a third period T3 allows for compensation of a characteristic of a second transistor M2. The length of this period may be varied for different color pixels. For example, the control signal driver 130 may differently set a time when the first compensation control signal GC_R having the gate-on voltage is applied to the first compensation control line 131, a time when the second compensation control signal GC_R having the gate-on voltage is applied to the second compensation control line 132, and a time when the third compensation control signal GC_B having the gate-on voltage is applied to the third compensation control line 133. The length of time of the third period T3 is therefore varied for each color pixel. In one embodiment, two or more color pixels may have a same period, provided at least two of the total number of color pixels is varied.

In FIG. 5, different color pixels are arranged on the same pixel row. Even in a case where different color pixels are arranged on the same pixel column, compensation control lines may be differently arranged and a compensation control signal application time may be differently set.

In FIG. 5, a case is illustrated where a third period T3_R of first color pixel PX1R<third period T3_G of second color pixel PX1G<third period T3_B of third color pixel PX1B. In another embodiment, a color pixel-based compensation period may be differently set depending on a current value of a driving transistor at a termination point of a determined compensation period, in correspondence with a color pixel-based current value of a selected grayscale value.

Due to deterioration caused by the number of uses and the elapse of operating time, the threshold voltage of the driving transistor of a pixel may shift and mobility of the driving transistor may be reduced. The amount of shift in the threshold voltage (ΔV_{TH}) and the mobility reduction rate (Δμ) increase due to deterioration. Also, current deviations of color pixels caused by a reduction in a threshold voltage shift amount and mobility may differ due to deterioration.

Since current deviations of color pixels caused by a reduction in the threshold voltage shift size and mobility of the driving transistor may differ, grayscale smear may occur differently in each color pixel when a characteristic of the driving transistor is compensated for with the same compensation time.

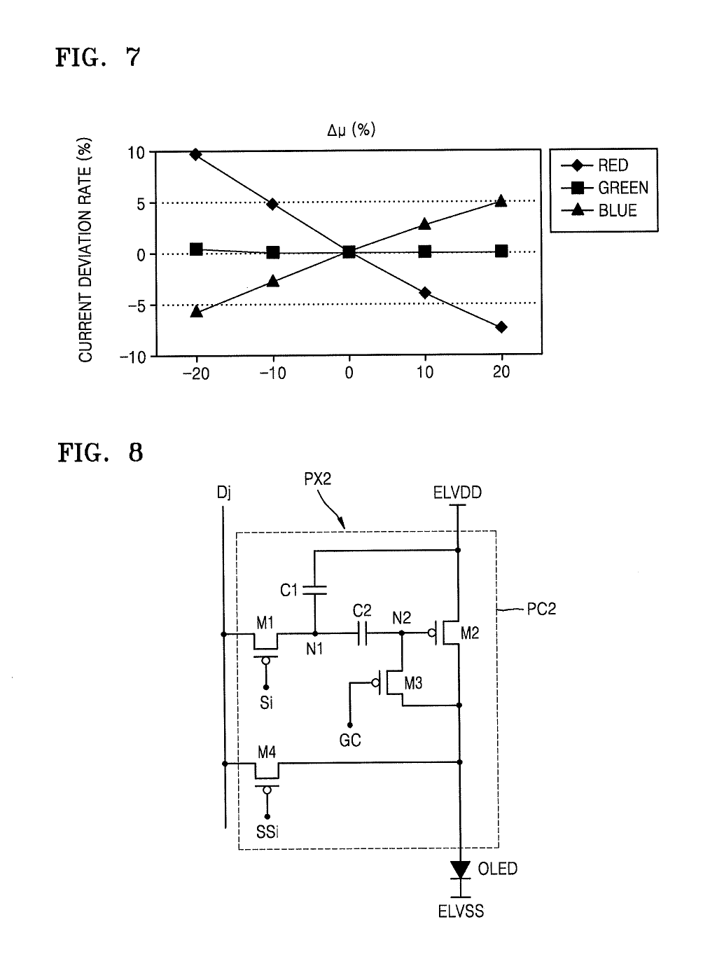

FIG. 7 illustrates an example of a current deviation rate based on a reduction in mobility of pixels in a certain grayscale range. Referring to FIG. 7, current deviations for a red pixel RED, a green pixel GREEN, and a blue pixel BLUE may differ based on a reduction or increase in mobility. For example, as the driving transistor deteriorates, distortion of white balance may increases and transition of color coordinates occurs.

In the present embodiment, a characteristic compensation period of the driving transistor is differently set for each color pixel. The characteristic compensation period of the driving transistor is set as a time when a current of the driving transistor at a compensation period termination point becomes a color pixel-based current of a certain gray scale. Therefore, the threshold voltage and mobility deviation of the driving transistor are compensated, and thus current deviation of each color pixel is reduced or minimized, which, in turn, reduces or minimizes white balance distortion.

FIG. 6 illustrates an example of current deviation rate based on a reduction in mobility of each pixel in a certain grayscale range. Compared to FIG. 7, a characteristic compensation period of a driving transistor is differently set for each pixel, and thus a difference between current deviations of color pixels is reduced due to a reduction or increase in mobility.

The characteristic compensation period of the driving transistor of each color pixel may be determined as a time when a current value of the driving transistor at a termination point of the characteristic compensation period becomes a current value of a color pixel of a certain gray scale (for example, a low grayscale value such as 32 or 64). The characteristic compensation period of the driving transistor of each color pixel may be determined by previously calculating a voltage (corresponding to a current value of the driving transistor at the termination point of the characteristic compensation period) at a gate electrode of the driving transistor.

FIG. 8 illustrates another embodiment of a pixel PX2 which includes a pixel circuit PC2 that supplies current to an organic light-emitting diode OLED. The pixel circuit PC2 includes first to fourth transistors M1 to M4 and first and second capacitors C1 and C2. Compared to pixel PX1 in FIG. 2, the pixel PX2 in FIG. 8 further includes the fourth transistor M4. The pixel PX2 in FIG. 8 may operate at the same timing as a driving timing in FIG. 3, and a third period T3 in which a characteristic of the second transistor M2 is compensated may be varied for each color pixel.

The characteristic compensation period of the driving transistor of each color pixel may be previously determined as a time when a current value of the driving transistor at a termination point of a characteristic compensation period becomes a current value of a color pixel of a certain gray scale (for example, a low gray scale such as 32 gray scale or 64 gray scale). The characteristic compensation period of the driving transistor of each color pixel may be determined by previously calculating a voltage (corresponding to a current value of the driving transistor at the termination point of the characteristic compensation period) at a gate electrode of the driving transistor.

In driving the pixel PX28, a deterioration sensing period of the fourth transistor M4 is provided in addition to the first to sixth periods T1 to T6 in FIG. 3. The deterioration sensing period may be performed before a non-display period, for example, after power-on or before power-off.

The fourth transistor M4 includes a gate electrode connected to a sensing line, a first electrode connected to a data line, and a second electrode connected to an anode electrode of an organic light-emitting diode OLED. The fourth transistor M4 is turned on by a sensing signal SSi applied through the sensing line, and extracts deterioration information of the organic light-emitting diode OLED and threshold voltage/mobility information of a second transistor M2.

The pixel PX2 turns on the second transistor M2 and the fourth transistor M4 to sense current flowing in the second transistor M2, thereby sensing the threshold voltage/mobility information of the second transistor M2. At this time, a first source voltage ELVDD and a second source voltage ELVSS are set in order to prevent current from flowing to the organic light-emitting diode OLED. The pixel PX2 turns off the second transistor M2, and turns on the fourth transistor M4 to sense a voltage at the anode electrode of the organic light-emitting diode OLED, thereby sensing the deterioration information of the organic light-emitting diode OLED.

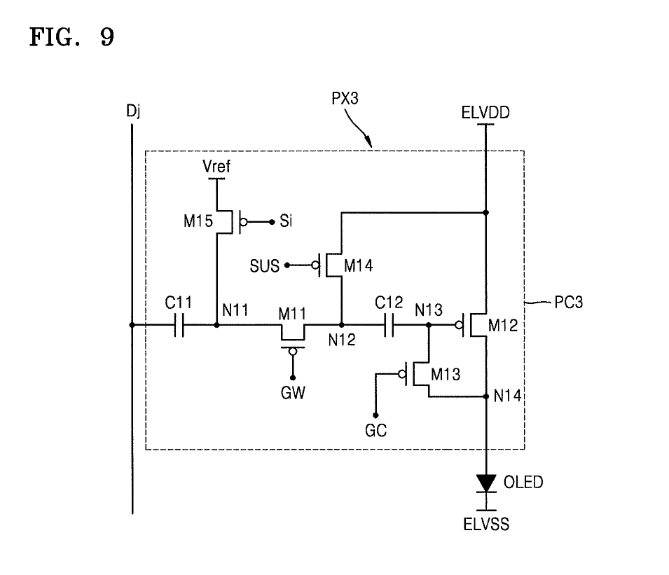

FIG. 9 illustrates another example of a pixel PX3 which includes a pixel circuit PC3 that supplies a current to an organic light-emitting diode OLED. The pixel circuit PC3 includes first to fifth transistors M11 to M15 and first and second capacitors C11 and C12. The first transistor M11 includes a gate electrode connected to a relay control line through which a relay control signal GW is applied, a first electrode connected to a first node N11, and a second electrode connected to a second node N12. The first transistor M11 is turned on by the relay control signal GW having a gate-on voltage, and connects the first node N11 to the second node N12.

The second transistor M12 includes a gate electrode connected to a third node N13, a first electrode connected to a first power source that supplies a first source voltage ELVDD, and a second electrode connected to an anode electrode of the organic light-emitting diode OLED. The second transistor M12 is turned on/off by a voltage of the third node N13, and thus controls a current supplied to the organic light-emitting diode OLED.

The third transistor M13 includes a gate electrode connected to a compensation control line through which a compensation control signal GC is applied, a first electrode connected to the third node N13, and a second electrode connected to the anode electrode of the organic light-emitting diode OLED and the second electrode of the second transistor M12. The third transistor M13 is turned on by the compensation control signal GC having a gate-on voltage to diode-connect the second transistor M12.

The fourth transistor M14 includes a gate electrode connected to an initialization control line through which an initialization control signal SUS is applied, a first electrode connected to the first power source, and a second electrode connected to the second node N12. The fourth transistor M14 is turned on by the initialization control signal SUS having the gate-on voltage, and transfers the first source voltage ELVDD to the second node N12.

The fifth transistor M15 includes a gate electrode connected to a scan line through which a scan signal Si is applied, a first electrode connected to a reference voltage source that supplies a reference voltage Vref, and a second electrode connected to the first node N11. The fifth transistor M15 is turned on by the scan signal Si having the gate-on voltage, and transfers the reference voltage Vref to the first node N11.

The first capacitor C11 includes a first electrode connected to a data line and a second electrode connected to the first node N11. The second capacitor C12 includes a first electrode connected to the second node N12 and a second electrode connected to the third node N13.

The anode electrode of the organic light-emitting diode OLED is connected to the pixel circuit PC3, and the cathode electrode is connected to a second power source that supplies a second source voltage ELVSS. The organic light-emitting diode OLED generates light having a certain luminance based on current from the pixel circuit PC3.

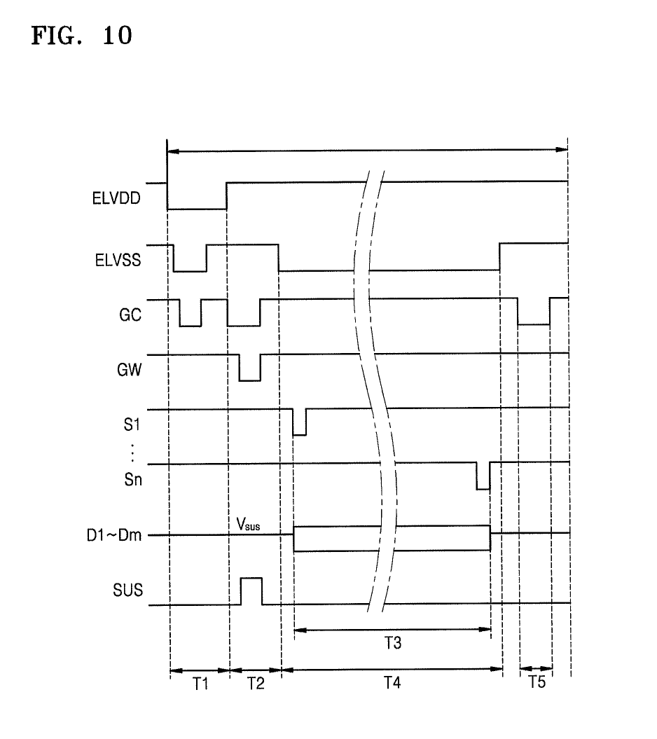

FIG. 10 is a timing diagram illustrating control signals for an embodiment of a method for driving organic light-emitting display apparatus 10 including the pixel PX3 in FIG. 9. Referring to FIGS. 9 and 10, the organic light-emitting display apparatus 10 is driven in a simultaneous emission driving scheme and operates in first to fifth periods T1 to T5 in each frame. The third period T3 overlaps the fourth period T4. The first source voltage ELVDD and the second source voltage ELVSS are applied as at least one or more voltage levels during one frame.

The first period T1 is an initialization period in which the second node N12 and the third node N13 are initialized. During the first period T1, the initialization signal SUS having a low level is applied, and the fourth transistor M14 is turned on. The first source voltage ELVDD having a low level is transferred to the second node N12 through the turned-on fourth transistor M14. Also, the compensation control signal GC having a low level is applied and the third transistor M13 is turned on. As the third transistor M13 is turned on, the third node N13 is connected to the fourth node N14, and a voltage of the third node N13 and a voltage of the fourth node N14 have a level similar to a low-level voltage of the first source voltage ELVDD. For example, the voltage of the third node N13 and a voltage at the anode electrode of the organic light-emitting diode OLED are reset to a low-level voltage.

The second period T2 is a compensation period in which a characteristic of the second transistor M12 is compensated. During the second period T2, the first source voltage ELVDD is applied as a high level and the compensation control signal GC is applied as a low level. The third transistor M13 is turned on by the compensation control signal GC, and diode-connects the second transistor M12. A voltage of the third node N13 is changed to “ELVDD+Vth” and Vth is changed to a voltage having a negative (−) value. ELVDD is a high-level voltage of the first source voltage ELVDD, and Vth is a threshold voltage of the second transistor M12 The relay control signal GW is applied as a low-level voltage and the initialization signal SUS is applied as a high-level voltage.

As the initialization signal SUS is applied as the high-level voltage, the fourth transistor M14 is turned off. As the relay control signal GW is applied as the low-level voltage, the first transistor M11 is turned on and the first node N11 is connected to the second node N12. At this time, a sustain voltage Vsus is applied from the data line. A data voltage of a previous frame, which is stored in a third period of the previous frame, is stored in the first capacitor C11. Therefore, a voltage in which a data signal of the previous frame is reflected is stored in the second capacitor C12.

In the present embodiment, the second period T2, in which a characteristic of the second transistor M12 is compensated, is varied for each pixel. The characteristic compensation period of the driving transistor of each color pixel may be previously determined, for example, as a time when a current value of the driving transistor at a termination point of the characteristic compensation period becomes a current value of a color pixel of a certain gray scale (for example, a low grayscale value of 32 or 64). The characteristic compensation period of the driving transistor of each color pixel may be determined by calculating a voltage (corresponding to a current value of the driving transistor at the termination point of the characteristic compensation period) at a gate electrode of the driving transistor.

The fourth period T4 is a period in which current, corresponding to a data voltage stored in each pixel PX3, is applied to the organic light-emitting diode OLED to emit light. During the fourth period T4, the first source voltage ELVDD is applied as a high level and the second source voltage ELVSS is applied as a low level. As the second source voltage ELVSS is changed to a low level, current flows to the organic light-emitting diode OLED through the second transistor M12 of each pixel PX3 and the organic light-emitting diode OLED emits light having a luminance corresponding to a data signal.

The third period T3 is a data writing period in which a data signal is applied to each pixel PX3. During the third period T3, scan signals S1 to Sn having a low level are sequentially applied to respective scan lines and turn on the fifth transistor M15. Data signals D1 to Dm are applied in response to the scan signals S1 to Sn. At this time, the relay control signal GW and the compensation control signal GC are applied as a high level, and the first transistor M11 and the third transistor M13 are turned off.

When the fifth transistor M15 is turned on, the reference voltage Vref is transferred to the first node N1. When a data signal is transferred to the data line while the reference voltage Vref is being transferred to the first node N1, a voltage corresponding to a difference between the reference voltage Vref and a data voltage is stored in the first capacitor C11. When a reference voltage transistor TR15 is turned off, the first node N11 is floated and a voltage stored in the first capacitor C11 is held. The voltage stored in the first capacitor C11 is used in the fourth period T4 of a next frame.

During the fifth period T5, the first source voltage ELVDD and the second source voltage ELVSS are applied as a high level and the compensation control signal GC is applied as a low level. The third transistor M13 is turned on by the compensation control signal GC and the third node N13 is connected to the fourth node N14, whereby a voltage of the third node N13 and a voltage of the fourth node N14 are reset to a certain voltage. For example, voltages of a gate, source, and drain of the second transistor M12 are applied as certain voltages and a response waveform of a pixel is improved. The fifth period T5 may be optionally omitted.

The transistors of the pixel circuit may be P-type transistors. In this case, a gate-on voltage for turning on the transistors is a low-level voltage and a gate-off voltage for turning off the transistors is a high-level voltage. Alternatively, the transistors of the pixel circuit may be N-type transistors. In this case, a gate-on voltage for turning on the transistors is a high-level voltage, and a gate-off voltage for turning off the transistors is a low-level voltage. The transistors may be an amorphous silicon thin film transistor, a low-temperature poly-silicon, or an oxide TFT. The oxide TFT may have an active layer of oxide such as amorphous indium-gallium-zinc-oxide (IGZO), zinc oxide (ZnO), or titanium oxide (TiO).

In accordance with another embodiment, an apparatus includes an output and a driver to supply signals to first and second pixels through the output. The first and second pixels are to emit light of different colors, and the driver is to supply a first compensation control signal to the first pixel and a second compensation control signal to the second pixel. The first compensation control signal has a first period and the second compensation control signal has a second period different from the first period. The first and second compensation control signals are to compensate for deviations in threshold voltages of driving transistors in respective ones of the first and second pixels. The first pixel may be a red pixel, the second pixel may be a green or blue pixel, and the second period is longer than the first period.

In this embodiment, the output may take various forms. For example, when the driver is embodied within an integrated circuit chip, the output may be one or more output terminals, leads, wires, ports, signal lines, or other type of interface without or coupled to the driver. The driver, for example, may be the control signal driver 130 in FIG. 1, or may be a driver circuit within or implemented with another driver such as a scan driver or data driver. The compensation control signals may be in accordance with any of the aforementioned embodiments.

The drivers, controllers, and other signal processors of the embodiments disclosed herein may be implemented in logic which, for example, may include hardware, software, or both. When implemented at least partially in hardware, the drivers, controllers, and other signal processors may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the drivers, controllers, and other signal processors may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

By way of summation and review, in an organic light-emitting display, the mobility and threshold voltages of the transistors change over time. For this reason, pixel luminance may not be able to be accurately determined. For example, luminance deviation may occur from characteristic differences between driving transistors of the pixels. This may result in a degradation of display quality.

In accordance with one or more of the aforementioned embodiments, a compensation period for a characteristic of the driving transistor of pixels in an organic light emitting display is differently set for at least two (and in one case all) color pixels. As a result, current deviation of each color pixel caused by characteristic reduction of the driving transistor is reduced or minimized, thereby reducing or minimizing white balance distortion.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An organic light-emitting display apparatus, comprising:
a plurality of color pixels, each of the color pixels including:
an organic light-emitting diode (OLED);
a driving transistor to control current to the OLED; and
a compensation transistor connected between an anode electrode of the OLED and a gate electrode of the driving transistor, wherein the compensation transistor is to be turned on based on a compensation control signal and wherein compensation control signals have different on-times for different color pixels.

2. The display apparatus as claimed in claim 1, wherein the color pixels include at least two of a red pixel, a green pixel, a blue pixel, or a white pixel.

3. The display apparatus as claimed in claim 2, wherein the on-time of the compensation control signal of each of the color pixels is based on a time when a current value of the driving transistor at a compensation period termination point becomes a current value of a predetermined grayscale value.

4. The display apparatus as claimed in claim 1, wherein each of the color pixels includes:
a second capacitor having a first electrode connected to a gate electrode of the driving transistor;
a first capacitor having a first electrode connected to a second electrode of the second capacitor and a second electrode connected to a first power source, the first power source to supply a first source voltage; and
a first transistor connected between the second electrode of the second capacitor and a data line, the first transistor to be turned on based on a scan signal to transfer a data signal to the first electrode of the first capacitor.

5. The display apparatus as claimed in claim 4, wherein each of the color pixels includes a fourth transistor connected between the data line and an anode electrode of the OLED, the fourth transistor to be turned on based on a sensing signal to sense deterioration of the driving transistor or the OLED.

6. The display apparatus as claimed in claim 1, wherein each of the color pixels includes:
a first capacitor connected between a data line and a first node;
a first transistor to connect the first node to a second node;
a second capacitor connected between the second node and a gate electrode of the driving transistor;
a fifth transistor to transfer a reference voltage to the first node; and
a fourth transistor connected between the second node and a first power source supplying a first source voltage, the fourth transistor to turn on based on an initialization control signal to transfer the first source voltage to the second node.

7. The display apparatus as claimed in claim 6, wherein the fifth transistor is to be turned on based on a scan signal to transfer the reference voltage to the first node.

8. The display apparatus as claimed in claim 6, wherein the first transistor is to be turned on by a relay control signal to connect the first node to the second node.

9. The display apparatus as claimed in claim 6, wherein when operation of emitting light from the OLED is simultaneously performed in the color pixels:
the first transistor is to be turned off,
the fifth transistor is to be turned on,
the reference voltage is to be transferred to the first node, and
a voltage corresponding to a data signal applied to the data line is to be stored in the first capacitor.

10. A method for driving an organic light-emitting display apparatus, the method comprising:
turning on a compensation transistor in each of a plurality of color pixels based on a compensation control signal, the compensation control signal to diode-connect a driving transistor in each of the color pixels;
sequentially applying a scan signal to the color pixels to apply a data signal to each of the color pixels connected to s scan line; and
simultaneously emitting light from the color pixels at a luminance corresponding to a current output to a driving transistor of each of the color pixels, wherein an on-time of the compensation control signal is differently set for different color pixels.

11. The method as claimed in claim 10, wherein the color pixels are at least two of a red pixel, a green pixel, a blue pixel, or a white pixel.

12. The method as claimed in claim 11, wherein the on-time of the compensation control signal of each of the color pixels is based on a time when a current value of the driving transistor at a compensation period termination point becomes a current value of a predetermined grayscale value.

13. The method as claimed in claim 10, wherein each of the color pixels includes:
a second capacitor having a first electrode connected to a gate electrode of the driving transistor;
a first capacitor having a first electrode, connected to a second electrode of the second capacitor and a second electrode connected to a first power source, the first power source to supply a first source voltage; and
a first transistor connected between a second electrode of the second capacitor and a data line, the first transistor to be turned on by a scan signal to transfer a data signal to the first electrode of the first capacitor.

14. The method as claimed in claim 13, wherein each of the color pixels includes a fourth transistor connected between the data line and an anode electrode of an organic light emitting diode (OLED), the fourth transistor to be turned on based on a sensing signal to sense deterioration of the driving transistor or the OLED.

15. The method as claimed in claim 10, wherein each of the color pixels includes:
a first capacitor connected between a data line and a first node;
a first transistor to connect the first node to a second node;
a second capacitor connected between the second node and a gate electrode of the driving transistor;
a fifth transistor to transfer a reference voltage to the first node; and
a fourth transistor connected between the second node and a first power source to supply a first source voltage, the fourth transistor to be turned on by an initialization control signal to transfer the first source voltage to the second node.

16. The method as claimed in claim 15, wherein sequentially supplying the scan signal includes:
turning off the first transistor,
turning on the fifth transistor;
transferring the reference voltage to the first node; and
storing a voltage in the first capacitor, the voltage corresponding to a data signal applied to the data line.

17. The method as claimed in claim 15, wherein simultaneously emitting light includes:
emitting light from an organic light emitting diode (OLED) according to current from the driving transistor based on the voltage stored in the second capacitor, wherein the voltage stored in the second capacitor is a voltage which is stored in the first capacitor during a scan operation of a previous frame.

18. The method as claimed in claim 10, wherein a scan period overlaps an emission period.

19. An apparatus, comprising:
an output; and
a driver to supply signals to first and second pixels through the output, wherein the first and second pixels are to emit light of different colors and wherein the driver is to supply a first compensation control signal to the first pixel and a second compensation control signal to the second pixel, the first compensation control signal having a first period and the second compensation control signal having a second period different from the first period, the first and second compensation control signals to compensate for deviations in threshold voltages of driving transistors in respective ones of the first and second pixels.

20. The apparatus as claimed in claim 19, wherein:
the first pixel is a red pixel,
the second pixel is a green or blue pixel, and
the second period is longer than the first period.
